(19) United States
(12) Patent Application Publication
(10) Pub. No.: US 2012/0187871 A1
(43) Pub. Date: Jul. 26, 2012

(54) LOW-PRESSURE DISCHARGE LAMP

(75) Inventors: Ursel Fantz, Kissing (DE); Roland Friedl, Augsburg (DE); Holger Hein, Augsburg (DE); Achim Hilscher, Friedberg (DE); Patrick Starke, Stadtbergen (DE)

(73) Assignee: OSRAM AG, Muenchen (DE)

(21) Appl. No.: 13/496,497

(22) PCT Filed: Sep. 17, 2009
(86) PCT No.: PCT/EP09/62059

§ 371 Date: Apr. 12, 2012

(51) Int. Cl. H01J 17/36; H01J 9/00; H01J 61/16; H01J 63/04; H01J 61/12; H01J 61/04

(52) U.S. Cl. 315/358; 313/637; 313/633; 313/643; 313/572; 313/485; 313/486; 315/326; 445/1

(57) ABSTRACT

A low-pressure discharge lamp includes a discharge vessel, a gas discharge medium including nitrogen contained in the discharge vessel at low pressure, wherein the discharge lamp is configured such that light may be generated by a high-current discharge process of the gas discharge medium.

### TECHNICAL FIELD

Embodiments of the present invention relate generally to a low-pressure discharge lamp, to a method of generating light and to a method of manufacturing a low-pressure discharge lamp.

### BACKGROUND

Up to the present, low-pressure discharge lamps such as fluorescent lamps commonly use mercury (Hg) as light-generating element. In addition, a background gas (also referred to as buffer gas), preferably a noble gas such as, for example, argon, is commonly provided. In conventional fluorescent lamps, the Hg is introduced into the lamp in liquid form or in the form of metal alloys. As a result of the self-heating of the lamp, part of the Hg vaporizes and is excited to irradiate ultraviolet (UV) radiation by means of a plasma discharge process in the lamp.

Disadvantages of low-pressure discharge lamps based on Hg include the following: (1) Hg is toxic and shall be prohibited in the long term for reasons of environmental protection, (2) an optimal Hg vapor pressure exists for light generation: if the lamp is too warm or too cold the luminous efficacy decreases, that is, the lamp has a strong temperature dependence, (3) radiation generated with Hg has a very short wavelength, which causes high conversion losses during the conversion into visible light.

There are attempts to replace Hg by metal halides. However, these compounds require high temperatures in order to be transformed into the gas-phase. Furthermore, these compounds are also largely harmful to the environment.

There are also approaches to use nitrogen (N₂) discharges, wherein the electrical energy is coupled into the system by means of inductive or capacitive coupling, and wherein the discharge is carried out in the glow-discharge mode with comparatively low discharge currents. In both cases, only rather limited power densities may be achieved.

### SUMMARY

It is an object of the invention to provide a low-pressure discharge lamp and a method of generating light that overcome at least some of the disadvantages of the conventional lamps outlined above.

The object is solved by the subject-matter claimed in the independent claims of the present application. Advantageous embodiments are described in the dependent claims.

A low-pressure discharge lamp in accordance with an embodiment of the invention includes a discharge vessel, a gas discharge medium including nitrogen contained in the discharge vessel at low pressure, wherein the discharge lamp is configured such that light may be generated by a high-current discharge process of the gas discharge medium.

A method of generating light in accordance with an embodiment of the invention includes initiating a high-current discharge process in a low-pressure nitrogen-containing gas discharge medium disposed in a discharge vessel of a low-pressure discharge lamp by feeding electrical energy into the gas discharge medium.

A method of manufacturing a low-pressure discharge lamp in accordance with an embodiment of the invention includes providing a discharge vessel with a gas discharge medium including nitrogen contained in the discharge vessel at low pressure, and configuring the discharge lamp such that light may be generated by a high-current discharge process of the gas discharge medium.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a low-pressure discharge lamp in accordance with an embodiment of the invention;

FIG. 1B shows a low-pressure discharge lamp in accordance with another embodiment of the invention;

FIG. 1C shows a low-pressure discharge lamp in accordance with another embodiment of the invention;

FIG. 1D shows a low-pressure discharge lamp in accordance with another embodiment of the invention;

FIGS. 1E and 1F show a low-pressure discharge lamp in accordance with an embodiment of the invention;

FIG. 1G shows a low-pressure discharge lamp in accordance with another embodiment of the invention;

FIG. 2A shows an arrangement including a low-pressure discharge lamp and an electrical power supply coupled to the lamp, in accordance with an embodiment of the invention;

FIG. 2B shows an arrangement including a low-pressure discharge lamp and an electrical power supply coupled to the lamp, in accordance with another embodiment of the invention;

FIG. 2C shows an arrangement including a low-pressure discharge lamp and an electrical power supply coupled to the lamp, in accordance with another embodiment of the invention;

FIG. 3A shows a diagram illustrating exemplary values for electrical operating parameters measured in various nitrogen arc discharge processes in accordance with an embodiment of the invention;

FIG. 3B shows a diagram illustrating a discharge spectrum obtained by an arc discharge process in a low-pressure discharge lamp in accordance with an embodiment of the invention;

FIG. 4A shows a diagram illustrating nitrogen UV emission intensities in nitrogen arc discharge processes for various compositions of the gas discharge medium in accordance with an embodiment of the invention;

FIG. 4B shows a diagram illustrating nitrogen visible emission intensities in nitrogen arc discharge processes for various compositions of the gas discharge medium in accordance with an embodiment of the invention;

FIG. 5 shows a method of generating light in accordance with an embodiment of the invention.

FIG. 6 shows a method of manufacturing a low-pressure discharge lamp in accordance with an embodiment of the invention;

FIG. 7 shows a schematic current-voltage diagram illustrating different gas discharge regimes.

### DESCRIPTION

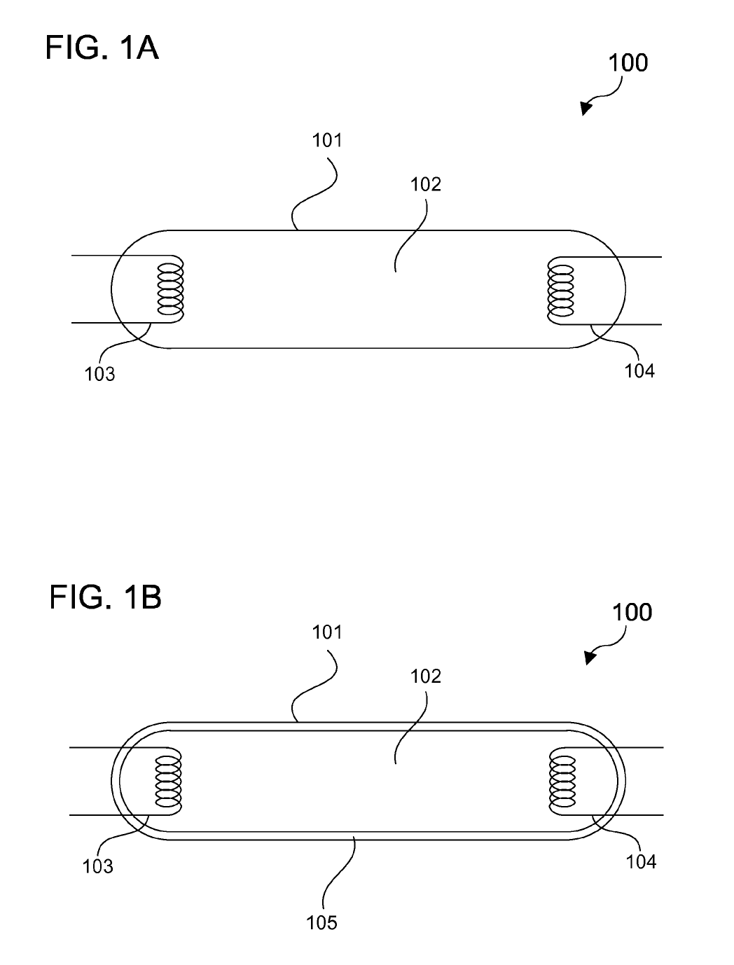

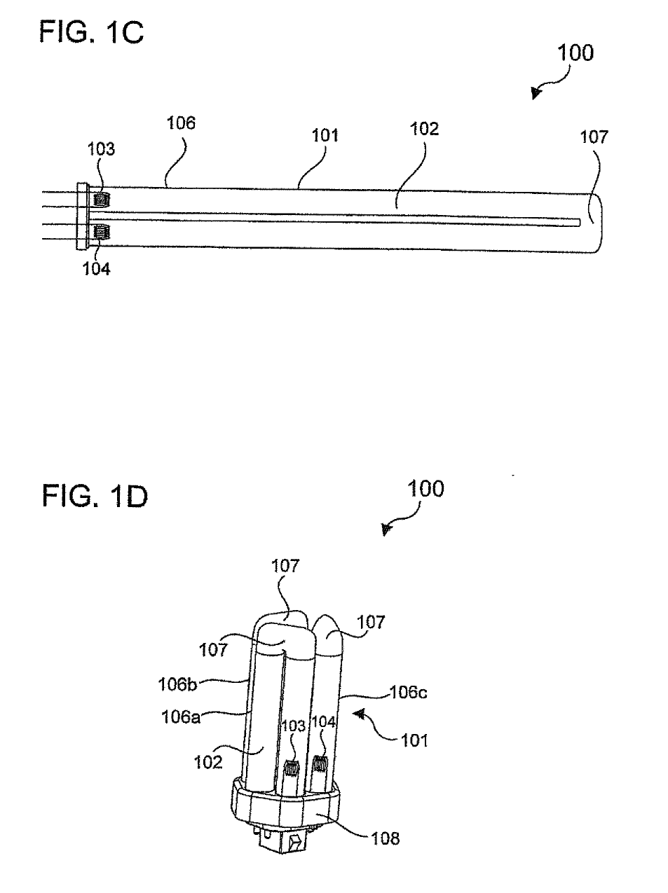

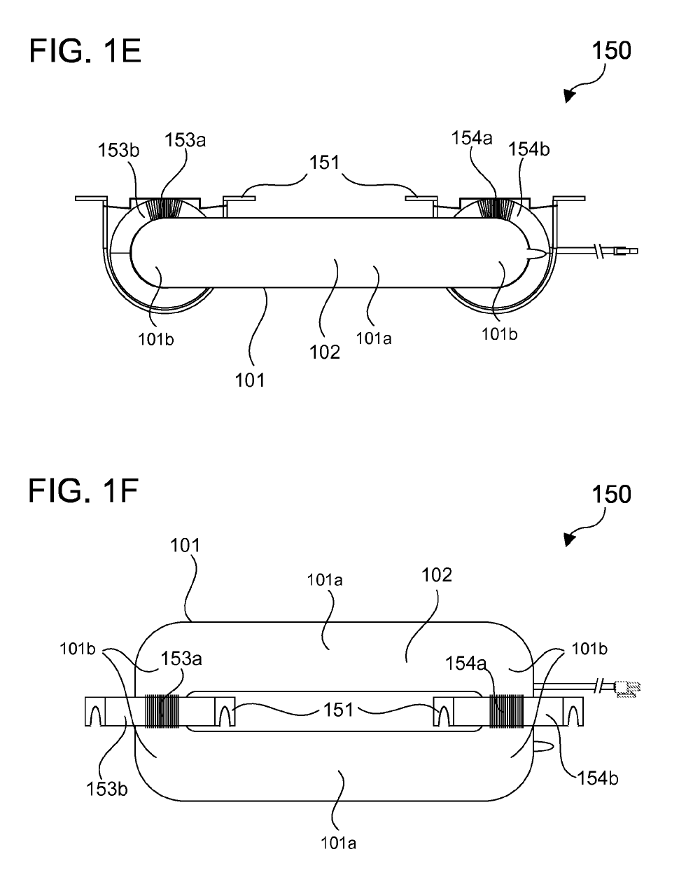

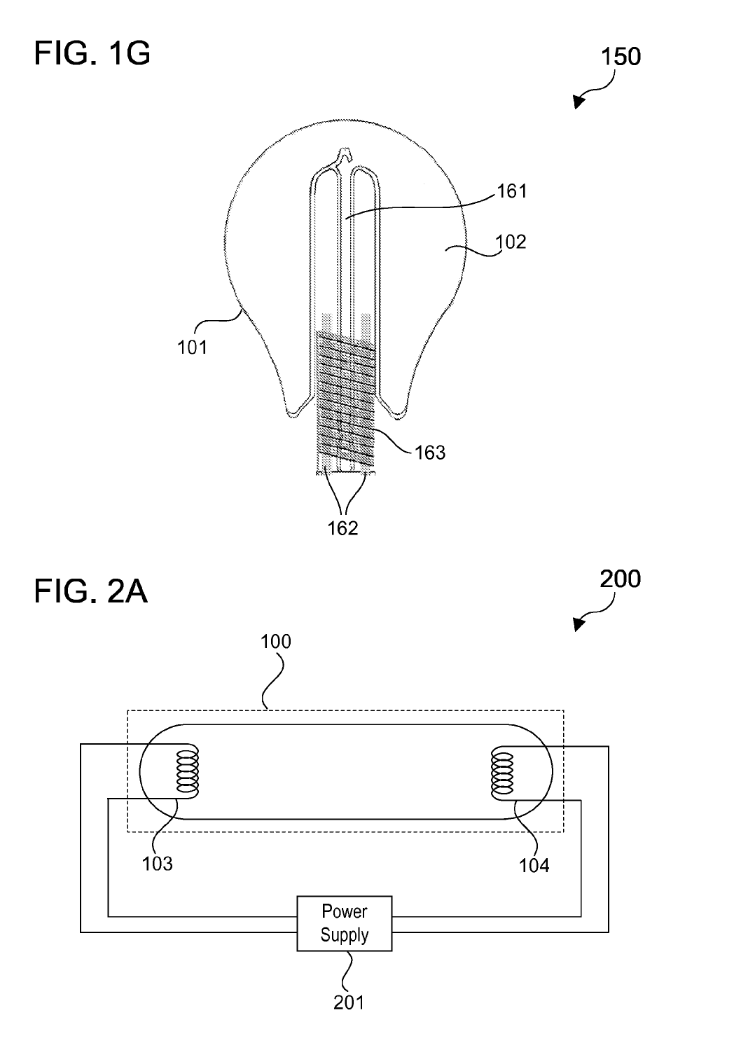

FIG. 1A shows a low-pressure discharge lamp 100 in accordance with an embodiment of the invention. The discharge lamp 100 includes a discharge vessel 101. In accordance with an embodiment, the discharge vessel 101 may have a tubular shape, wherein in this application the term “tubular” may be understood to include discharge vessels that are considerably elongate, that is discharge vessels, wherein the diameter of their (not necessarily circular) cross-section is considerably smaller than their length.

For example, in accordance with an embodiment the discharge vessel 101 of the low-pressure discharge lamp 100 may have the same or similar shape and/or dimensions as discharge vessels of typical fluorescent tubes based on mercury. In accordance with alternative embodiments, the discharge vessel 101 may have the same or similar shape and/or dimensions as discharge vessels of typical compact fluorescent lamps (CFL) (also known as single capped fluorescent lamps, compact fluorescent lights or energy saving lights), including for example tubular shapes having one or more bends (cf. FIGS. 1C and 1D) or shapes having a spiral geometry. In accordance with other embodiments the discharge vessel 101 may have other suitable shapes and/or dimensions.

In case that the discharge vessel 101 is configured as a discharge tube, the discharge tube may have suitable geometric dimensions, for example a tube length in the range from approximately 10 cm to approximately 200 cm, e.g. 35 cm in accordance with an embodiment, and/or for example a tube diameter in the range from approximately 7 mm to approximately 50 mm in accordance with an embodiment, e.g. 25 mm in accordance with an embodiment, although in accordance with alternative embodiments, the discharge tube may have other values of its length and/or diameter.

In accordance with an embodiment, the discharge vessel 101 may include or may be made of a material that is transparent for visible light. For example, in accordance with an embodiment, the discharge vessel 101 may include or may be made of glass, although in accordance with other embodiments, the discharge vessel 101 may include or may be made of other materials.

The discharge lamp 100 further includes a gas discharge medium 102 including nitrogen that is contained in the discharge vessel 101 at low pressure. In accordance with an embodiment, the gas discharge medium 102 may have a pressure of less than or equal to approximately 150 torr (200 mbar), for example in the range from approximately 0.1 torr to approximately 40 torr in accordance with an embodiment, e.g. approximately 1 torr in accordance with an embodiment.

In accordance with an embodiment, the gas discharge medium 102 may contain 100% nitrogen. In other words, the gas discharge medium 102 may consist of nitrogen.

In accordance with another embodiment, the gas discharge medium 102 may further include a noble gas. In other words, the gas discharge medium 102 may include at least one noble gas in addition to nitrogen. In accordance with an embodiment, the noble gas may be or may include at least one of the following gases: argon (Ar), helium (He), neon (Ne), krypton (Kr), xenon (Xe).

In accordance with some embodiments, the noble gas (e.g. Ar) may serve as background gas for the discharge process. In this case, the gas discharge medium 102 may have a nitrogen percentage that is less than or equal to approximately 100% in accordance with an embodiment, for example a nitrogen percentage in the range from approximately 0.1% to approximately 10% in accordance with an embodiment, e.g. approximately 5% in accordance with an embodiment.

In accordance with an embodiment, the gas discharge medium 102 may be a nitrogen-argon mixture, wherein the percentage of nitrogen may be approximately 10% in accordance with an embodiment, or approximately 5% in accordance with another embodiment, or approximately 1% in accordance with another embodiment, or approximately 0.5% in accordance with another embodiment, or approximately 0.1% in accordance with another embodiment.

The discharge lamp 100 further includes a first electrode 103 and a second electrode 104 disposed at least in part in the discharge vessel 101. The electrodes 103, 104 may serve as cathode and anode of the discharge lamp 100. In accordance with an embodiment, for example in case that the discharge vessel 101 is configured as a discharge tube, the first and second electrodes 103, 104 may be disposed at or near opposite ends of the discharge vessel 101, as shown in FIG. 1A, although in accordance with other embodiments, the first and second electrodes 103, 104 may be arranged differently. In accordance with an embodiment, a distance between the first electrode 103 and the second electrode 104 may be in the range from approximately 5 cm to approximately 195 cm, for example approximately 26.5 cm in accordance with an embodiment. In case that the discharge vessel 101 is configured as a straight discharge tube, the discharge length may correspond to the length of the discharge lamp 100.

In accordance with an embodiment, at least one of the first and second electrodes 103, 104 may include an oxide material. In accordance with an embodiment, the first electrode 103 or the second electrode 104 may include an oxide material. In accordance with another embodiment, the first electrode 103 and the second electrode 104 may include an oxide material.

In accordance with an embodiment, the oxide material may include at least one of the following oxides: barium oxide, strontium oxide, calcium oxide.

In accordance with an embodiment, at least one of the first and second electrodes 103, 104 may include tungsten (W) material. For example, in accordance with an embodiment, the electrode or electrodes that include the oxide material may further include tungsten material, wherein the tungsten material may be covered (in other words, coated) by the oxide material in accordance with an embodiment.

In accordance with an embodiment, at least one of the first and second electrodes 103, 104 may be configured as or may include a spiral-wound filament, in other words a wire that is wound up as a spiral, as shown in FIG. 1A. However, in accordance with other embodiments, the electrodes may have a different shape.

In accordance with an embodiment, the filament may be a tungsten wire that may be coated with the oxide material.

In accordance with some embodiments, the oxide material may serve as emitter material and may, for example, serve to lower the work function of the respective electrode.

The discharge lamp 100 is configured such that light may be generated by a high-current discharge process (clearly, an arc discharge process in accordance with the embodiment shown) of the gas discharge medium 102 between the first electrode 103 and the second electrode 104.

In accordance with another embodiment, the discharge lamp 100 shown in FIG. 1A may further include a phosphor 105 that may be disposed in the discharge vessel 101, as shown in FIG. 1B.

In accordance with an embodiment, the phosphor 105 may be disposed at the inner surface of the discharge vessel 101 as shown in FIG. 1B. In accordance with an embodiment, the inner surface of the discharge vessel 101 may be coated by a thin film of the phosphor. In other words, the discharge lamp 100 may include a phosphor coating at the inside of the discharge vessel 101.

In accordance with an embodiment, the phosphor 105 may be configured to at least partially absorb light energy in the ultraviolet (UV) wavelength range.

In accordance with an embodiment, the phosphor 105 may be further configured to at least partially re-emit the absorbed light energy as visible light, in other words, as electromagnetic radiation having at least one wavelength in the visible spectrum.

In accordance with an embodiment, the phosphor 105 may be configured to convert ultraviolet radiation generated by the gas discharge medium, e.g. by the nitrogen, in the arc discharge process into visible radiation, in other words visible electromagnetic radiation or visible light.

In accordance with an embodiment, the phosphor 105 may be configured to re-emit the absorbed light energy as visible light in the blue range or blue/green range of the visible spectrum.

In accordance with an embodiment, the phosphor 105 may be configured to absorb light energy in the wavelength range from approximately 260 nm to approximately 400 nm and re-emit the absorbed light energy as light having an emission maximum in the wavelength range from approximately 450 nm to approximately 550 nm.

In accordance with an embodiment, the phosphor 105 may include an Eu²⁺ doped phosphor.

In accordance with an embodiment, the phosphor 105 may include an aluminate material, for example an Eu²⁺ doped aluminate in accordance with an embodiment.

In accordance with an embodiment, the phosphor 105 may include at least one of the following materials: barium-magnesium-aluminate:Eu (BaMgAl₁₀O₁₇:Eu), (Ba₁₋ₓSrₓ)MgAl₁₀O₁₇:Eu,Mn, strontium-aluminate (Sr₄Al₁₄O₂₅:Eu).

In accordance with an embodiment, the gas discharge medium 102 may further include hydrogen. One effect of adding hydrogen may be that the emission spectrum of the discharge lamp 100 may be varied. In accordance with alternative embodiments, other suitable gas additions such as, for example, oxygen may be used in addition to or instead of hydrogen.

FIGS. 1C and 1D show low-pressure discharge lamps 100 in accordance with other embodiments, wherein light may be generated by a high-current discharge process (clearly, an arc discharge process in accordance with the embodiments shown). The discharge lamps 100 are different from the one shown in FIG. 1A in that the discharge vessel 101 in each case has a shape that is similar to a shape commonly used in compact fluorescent lamps (CFL).

In the discharge lamp 100 shown in FIG. 1C, the discharge vessel 101 is configured as a tube 106 having a single bend 107. Electrodes 103, 104 are located in the tube 106. In accordance with an embodiment, a phosphor may be coated on the inner walls of the tube 106 (not shown, cf. FIG. 1B), although in accordance with other embodiments, the phosphor may not be present.

The lamp 100 shown in FIG. 1D is different from the lamp 100 shown in FIG. 1C in that the discharge vessel 101 of the lamp 100 shown in FIG. 1D is configured to have a first 106a, second 106b and third bended tube 106c joined together, in other words three bended tubes joined together. In accordance with an embodiment, the discharge lamp 100 may include a socket 108, wherein the tubes 106a, 106b and 106c may be mounted on the socket 108, as shown in FIG. 1D.

In accordance with an embodiment, the tube diameter of the tubes 106, 106a, 106b, 106c may be in the range from approximately 7 mm to approximately 20 mm, although in accordance with other embodiments, the tube diameter may have a different value. In accordance with another embodiment, the discharge length may be in the range from approximately 100 mm to approximately 1000 mm, although in accordance with other embodiments, the discharge length may be different. In accordance with another embodiment, the lamp length may be in the range from approximately 50 mm to approximately 200 mm, although in accordance with other embodiments, the lamp length may be different.

In accordance with other embodiments, the discharge vessel 101 may be configured such that the discharge vessel 101 includes a number of bended tubes joined together that is different from three, for example two bended tubes joined together or four bended tubes joined together, although in accordance with other embodiments, the number of bended tubes joined together may be greater than four.

It has to be noted that the shapes of the discharge vessels 101 shown in FIGS. 1A to 1D are only exemplary and that, in general, any suitable shape of a discharge vessel may be used for a low-pressure nitrogen discharge process in accordance with embodiments described herein.

FIGS. 1E and 1F show a low-pressure discharge lamp 150 in accordance with another embodiment of the invention. FIG. 1E shows a side view of the discharge lamp 150 and FIG. 1F shows a top view of the discharge lamp 150. The discharge lamp 150 includes a discharge vessel 101 and further includes a gas discharge medium 102 including nitrogen contained in the discharge vessel 101 at low pressure. The discharge lamp 150 is configured such that light may be generated by a high-current discharge process of the gas discharge medium 102 by means of inductive coupling of electrical energy into the gas discharge medium 102 as will be explained further below.

The gas discharge medium 102 may be configured in accordance with one of the embodiments described herein, e.g. with respect to the composition of the gas discharge medium 102 or its pressure.

In accordance with the embodiment shown, the discharge vessel 101 has a toroidal shape with two elongated straight sections 101a disposed parallel to one another and two shorter sections 101b joining the elongated sections 101a with one another at respective opposite ends of the elongated sections 101a. Clearly, the discharge vessel 101 has a shape that resembles a stretched loop.

In accordance with an embodiment, the discharge vessel 101 may include or may be made of a material that is transparent for visible light. For example, in accordance with an embodiment, the discharge vessel 101 may include or may be made of glass, although in accordance with other embodiments, the discharge vessel 101 may include or may be made of other materials.

In accordance with an embodiment, a phosphor may be disposed in the discharge vessel 101, for example coated on the inner surface of the discharge vessel 101 (not shown in FIGS. 1E and 1F, cf. FIG. 1B). The phosphor may be configured in accordance with one of the embodiments described herein. In accordance with alternative embodiments, a phosphor may not be present (as shown).

The discharge lamp 150 further includes first and second power couplers 153b, 154b that may be used for inductively coupling the energy used to ignite and operate the lamp 150 into the discharge medium 102. The power couplers 153b, 154b have a ring-like shape and are mounted on the shorter sections 101b of the discharge vessel 101. That is, a first ring-shaped power coupler 153b encloses a first one of the sections 101b and a second ring-shaped power coupler 154b encloses a second one of the sections 101b of the discharge vessel 101, as shown in FIGS. 1E and 1F. A first coil 153a is mounted on the first power coupler 153b and a second coil 154a is mounted on the second power coupler 154b. The first and second coils 153a, 154a may in each case be realized by a wire winding that may be wound around at least a portion of the corresponding power coupler 153b, 154b. Each of the power couplers 153b, 154b clearly may serve as a coil core and may serve to enhance a magnetic field that may be generated by the corresponding coil 153a, 154a. Thus, in accordance with an embodiment each of the power couplers 153b, 154b may include or may be made of a suitable coil core material such as, for example, ferrite material or any other suitable material that may be used as coil core material, e.g. as coil core material for a high-frequency coil.

In the discharge lamp 150 in accordance with the embodiment shown in FIGS. 1E and 1F, a nitrogen high-current discharge process may be initiated by inductively coupling electrical energy into the gas discharge medium 102 by means of the coils 153a, 154a and the power couplers 153b, 154b. Therefore, an alternating electrical current, e.g. a high-frequency alternating current in the kHz range, may be conducted through the coils 153a, 154a which then in each case generate a magnetic field that may be enhanced by the corresponding power couplers 153b, 154b. Thus, a ring discharge may be ignited and maintained without electrodes by means of a magnetic field, e.g. a high-frequency magnetic field. Clearly, the discharge lamp 150 is configured as an electrodeless low-pressure discharge lamp.

In accordance with an embodiment, the discharge lamp 150 may further include mounting brackets 151 for mounting the discharge lamp 150 to a mounting location.

The lamp structure shown in FIGS. 1E and 1F may also be referred to as externally coupled induction lamp.

FIG. 1G shows a cross-sectional view of a low-pressure discharge lamp 150 in accordance with another embodiment of the invention. The discharge lamp 150 includes a discharge vessel 101 and further includes a gas discharge medium 102 including nitrogen contained in the discharge vessel 101 at low pressure. The discharge lamp 150 is configured such that light may be generated by a high-current discharge process of the gas discharge medium 102 by means of inductive coupling of electrical energy into the gas discharge medium 102 as will be explained further below.

The gas discharge medium 102 may be configured in accordance with one of the embodiments described herein, e.g. with respect to the composition of the gas discharge medium 102 or its pressure.

In accordance with the embodiment shown, the outer shape of the discharge vessel 101 is similar to that of a conventional light bulb. In accordance with an embodiment, the geometric dimensions of the discharge lamp 150 may be similar or equal to those of a conventional light bulb. An exhaust tube 161 is located in a center portion of the discharge lamp 150 and is connected with the discharge vessel 101. A tube 162 encloses a lower portion of the exhaust tube 161. A coil 163 is mounted on the tube 162. The coil 163 may be realized by a wire winding that may be wound around at least a portion of the tube 162. The tube 162 may clearly serve as an antenna and may include or may be made of a ferrite material or any other suitable material that may be used for an antenna, e.g. for a high-frequency antenna.

In accordance with an alternative embodiment, the hollow tube 162 may be replaced by a massive rod. In this case, the exhaust tube 161 may be located at a different position in the discharge lamp 150.

In accordance with an embodiment, the discharge vessel 101 may include or may be made of a material that is transparent for visible light. For example, in accordance with an embodiment, the discharge vessel 101 may include or may be made of glass, although in accordance with other embodiments, the discharge vessel 101 may include or may be made of other materials.

In accordance with an embodiment, a phosphor may be disposed in the discharge vessel 101, for example coated on the inner surface of the discharge vessel 101 (not shown in FIG. 1G, see FIG. 1B). The phosphor may be configured in accordance with one of the embodiments described herein. In accordance with alternative embodiments, a phosphor may not be present (as shown).

In the low-pressure discharge lamp 150 in accordance with the embodiment shown in FIG. 1G, a nitrogen high-current discharge process may be initiated and maintained by inductively coupling electrical energy into the gas discharge medium 102 by means of the coil 161 and the tube 162. Therefore, an alternating electrical current, e.g. a high-frequency alternating current in the MHz range in accordance with an embodiment, may be conducted through the coil 161 which then generates an alternating magnetic field, e.g. a high-frequency magnetic field in the MHz range in accordance with an embodiment. In this connection, the tube 162 may serve as an antenna to transmit the magnetic field and thus energy into the gas discharge medium 102 such that the discharge process may be carried out. Clearly, the discharge lamp 150 is configured as an electrodeless low-pressure discharge lamp.

The lamp structure shown in FIG. 1G may also be referred to as internally coupled induction lamp.

In this context, it is noted that the structures shown in FIGS. 1E to 1G are only exemplary structures for discharge lamps with inductive coupling. In accordance with other embodiments, any other lamp structure with inductive coupling that is suitable for a low-pressure nitrogen based high-current discharge may be used.

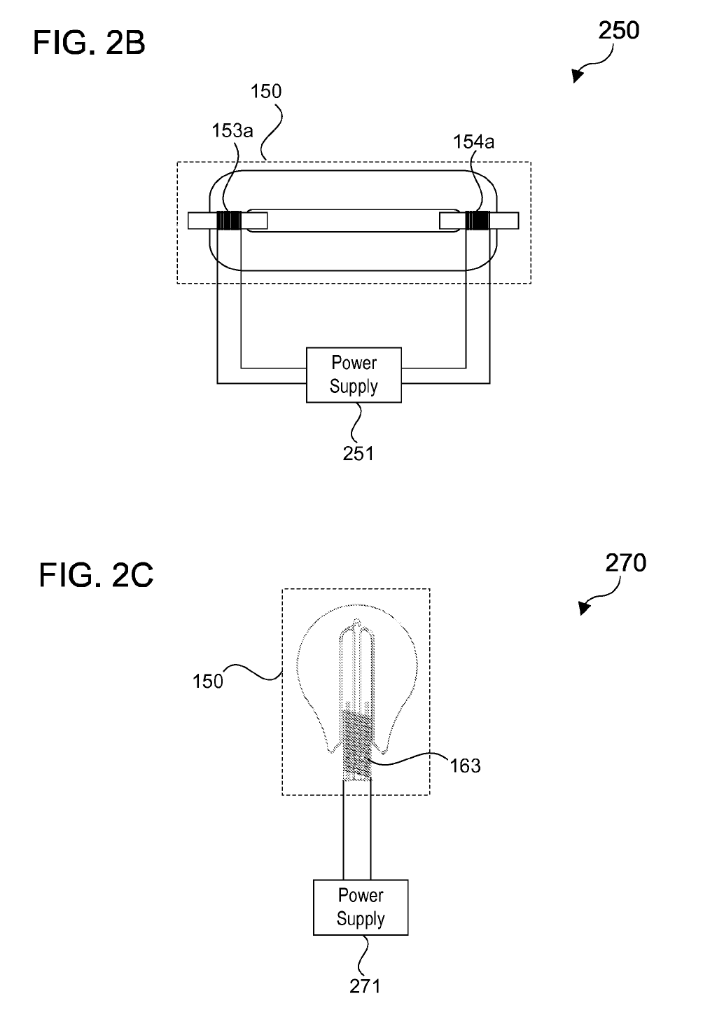

FIG. 2A shows an arrangement 200 including a low-pressure discharge lamp 100 including first and second electrodes 103, 104, and a power supply 201 coupled to the first and second electrodes 103, 104 of the discharge lamp 100, in accordance with an embodiment of the invention. The discharge lamp 100 may be configured in accordance with one or more embodiments described herein, e.g. with one or more embodiments described in connection with FIGS. 1A to 1D. The power supply 201 may be used to supply electrical power used to operate the discharge lamp 100. In accordance with an embodiment, the power supply 201 may be configured as an AC power supply.

In accordance with some embodiments the power supply 201 may be configured such that the discharge lamp 100 may be operated with alternating current having a frequency on the order of several 10 kHz, for example about 20 kHz in accordance with an embodiment, similar to conventional fluorescent lamps, although in accordance with other embodiments the discharge lamp 100 may be operated at other frequencies.

In accordance with an embodiment, the power supply 201 may be configured as an electronic ballast. In accordance with an embodiment, the electronic ballast may be an external ballast, in other words an electronic ballast that is separate from the discharge lamp 100. In accordance with another embodiment, the electronic ballast may be included or integrated in the discharge lamp 100. In other words, the discharge lamp 100 may be configured as a self-ballasted lamp in accordance with this embodiment.

In accordance with another embodiment, the power supply 201 may be configured as a DC power supply.

FIG. 2B shows an arrangement 250 including a low-pressure discharge lamp 150 including first and second coils 153a, 154a, and a power supply 251 coupled to the first and second coils 153a, 154a of the discharge lamp 150, in accordance with another embodiment of the invention. The discharge lamp 150 is configured as an externally coupled induction lamp and may be configured in accordance with one or more embodiments described herein, e.g. in accordance with one or more embodiments described in connection with FIGS. 1E and 1F. The power supply 251 may be used to supply electrical power used to operate the discharge lamp 150. In accordance with an embodiment, the power supply 251 may be configured as an AC power supply, e.g. as a high-frequency AC power supply in accordance with an embodiment.

In accordance with some embodiments the power supply 251 may be configured such that the discharge lamp 150 may be operated with alternating current having a frequency larger than about 100 kHz, for example in the range from approximately 150 kHz to approximately 400 kHz, for example about 250 kHz in accordance with an embodiment, although in accordance with other embodiments, the discharge lamp 150 may be operated at other frequencies.

In accordance with an embodiment, the power supply 251 may be configured as an electronic ballast. In accordance with an embodiment, the electronic ballast may be an external ballast, in other words an electronic ballast that is separate from the discharge lamp 150. In accordance with another embodiment, the electronic ballast may be included or integrated in the discharge lamp 150. In other words, the discharge lamp 150 may be configured as a self-ballasted lamp in accordance with this embodiment.

FIG. 2C shows an arrangement 270 including a low-pressure discharge lamp 150 including a coil 163, and a power supply 271 coupled to the coil 163 of the discharge lamp 150, in accordance with an embodiment of the invention. The discharge lamp 150 is configured as an internally coupled induction lamp and may be configured in accordance with one or more embodiments described herein, e.g. in accordance with one or more embodiments described in connection with FIG. 1G. The power supply 271 may be used to supply electrical power used to operate the discharge lamp 150. In accordance with an embodiment, the power supply 271 may be configured as an AC power supply, e.g. as a high-frequency AC power supply.

In accordance with some embodiments the power supply 271 may be configured such that the discharge lamp 150 may be operated with alternating current having a frequency larger than about 1 MHz, for example in the range from approximately 2 MHz to approximately 3 MHz in accordance with an embodiment, e.g. about 2.5 MHz in accordance with an embodiment, although in accordance with other embodiments, the discharge lamp 150 may be operated at other frequencies.

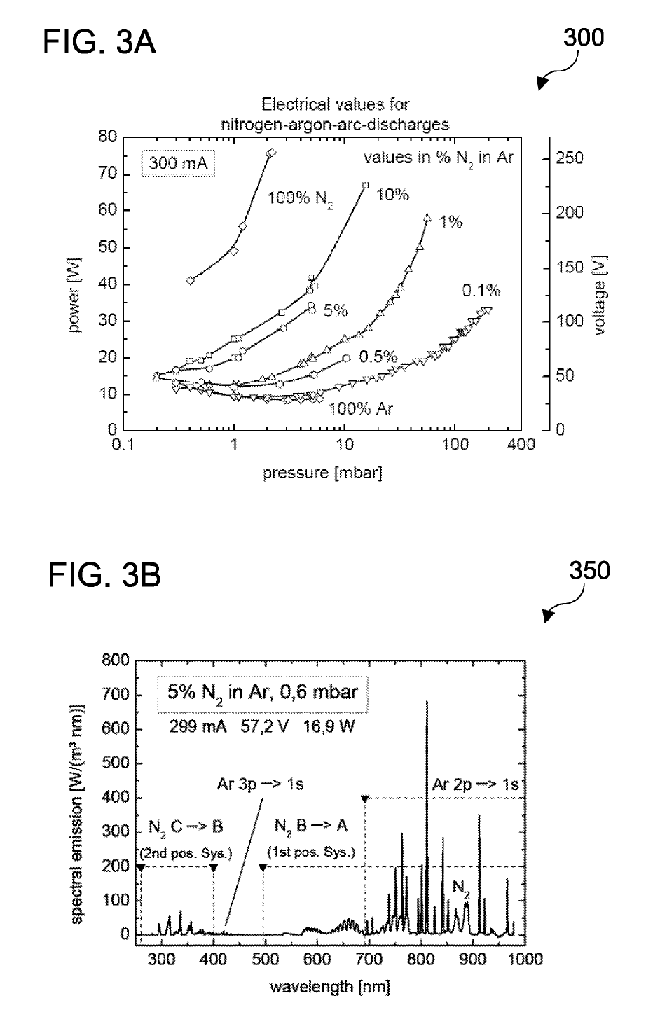

FIG. 3A shows a diagram 300 illustrating exemplary values for electrical operating parameters measured in various nitrogen arc discharge processes in accordance with an embodiment of the invention. The diagram 300 shows the electrical power over the total pressure for a nitrogen-argon gas mixture as gas discharge medium and various percentages of nitrogen (N₂) in argon (Ar), namely 0.1% N₂ in Ar, 0.5% N₂ in Ar, 1% N₂ in Ar, 5% N₂ in Ar, 10% N₂ in Ar and 100% N₂. The discharge current is approximately 300 mA in each case, as shown in diagram 300. Furthermore, the corresponding burning voltages (also referred to as lamp voltages) are shown on a separate axis on the right-hand side of diagram 300. In this context, it is noted that there is no exact linear relationship between voltage and power. However, the voltage axis shows the burning voltages with an accuracy of about ±9%.

FIG. 3B shows a diagram 350 illustrating an exemplary discharge spectrum obtained by a nitrogen arc discharge process in a low-pressure discharge lamp in accordance with an embodiment of the invention. The spectrum corresponds to an arc discharge in a discharge lamp with a gas discharge medium made up of a nitrogen-argon gas mixture having 5% nitrogen and a total pressure of 0.6 mbar, as shown in diagram 350. The electrical operating parameters of the discharge process are 299 mA for the discharge current, 57.2 V for the burning voltage and 16.9 W for the electrical power, as shown in the diagram 350. It is shown in diagram 350 that the nitrogen discharge spectrum has a first band system (also referred to as first positive system or N₂ B→A transition) in the wavelength range between 500 nm and 2500 nm (referred to as “N₂ B→A (1st pos. Sys.)” in diagram 350), which includes wavelengths in the visible (VIS) light range between 500 nm and 750 nm, and a second band system (also referred to as second positive system or N₂ C→B transition) in the near ultraviolet (UV) range between 260 nm and 400 nm (referred to as “N₂ C→B (2nd pos. Sys.)” in diagram 350). In accordance with an embodiment, a suitable phosphor (such as, for example, one of the phosphors described herein) may be used in the lamp to convert the emitted UV radiation into visible light. In accordance with other embodiments, addition of hydrogen and/or oxygen and/or other gases to the gas discharge medium or variation of the background gas or the pressure may be used to decrease or increase the UV part or the VIS part of the discharge spectrum. In accordance with the embodiment shown in FIG. 3B, the arc discharge spectrum further includes argon emission lines obtained by Ar 3p→1s and Ar 2p →1s transitions, as shown in diagram 350.

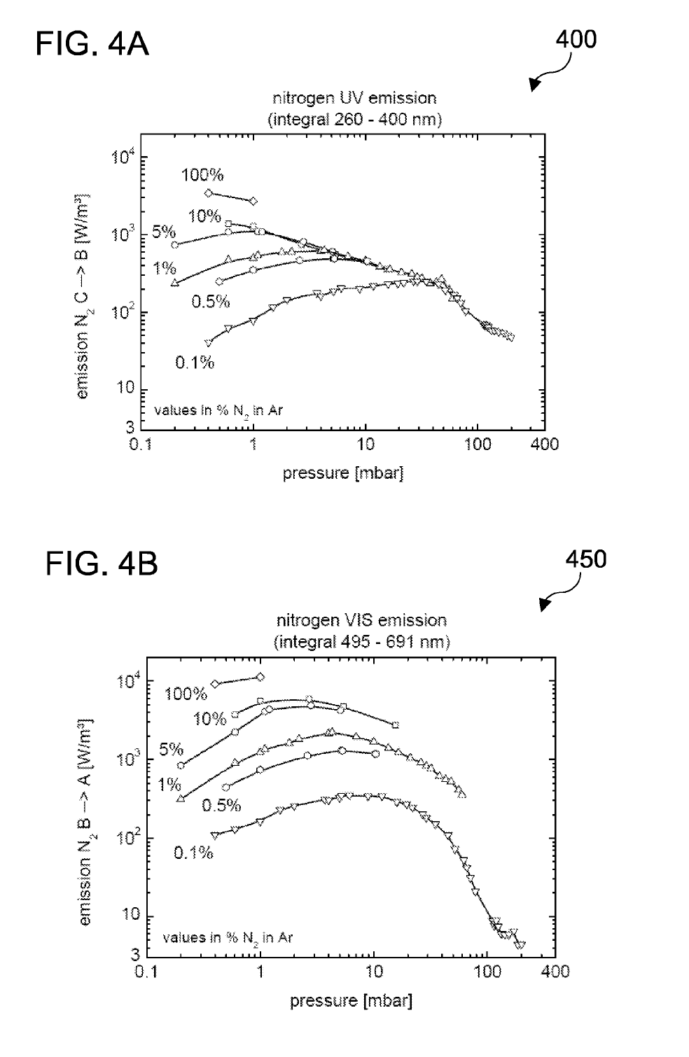

FIG. 4A shows a diagram 400 illustrating nitrogen ultraviolet (UV) emission intensities (N₂ C→B transitions) in nitrogen arc discharge processes for various compositions of the gas discharge medium in accordance with an embodiment. It is shown the integral N₂ UV emission over the total pressure for a nitrogen-argon gas mixture as gas discharge medium and various percentages of nitrogen (N₂) in argon (Ar), namely 0.1% N₂ in Ar, 0.5% N₂ in Ar, 1% N₂ in Ar, 5% N₂ in Ar, 10% N₂ in Ar and 100% N₂. The lower and upper integration limits are 260 nm and 400 nm, respectively, as labeled in diagram 400.

FIG. 4B shows a diagram 450 illustrating nitrogen visible (VIS) emission intensities (N₂ B→A transitions) in nitrogen arc discharge processes for various compositions of the gas discharge medium in accordance with an embodiment. It is shown part of the integral N₂ VIS emission over the total pressure for a nitrogen-argon gas mixture as gas discharge medium and various percentages of nitrogen (N₂) in argon (Ar), namely 0.1% N₂ in Ar, 0.5% N₂ in Ar, 1% N₂ in Ar, 5% N₂ in Ar, 10% N₂ in Ar and 100% N₂. The lower and upper integration limits are 495 nm and 691 nm, respectively, as labeled in diagram 450.

FIGS. 3A, 3B, 4A and 4B show that a low-pressure nitrogen high-current discharge may be initiated, in other words ignited, and maintained for various values of the discharge gas composition, in particular the nitrogen percentage in the discharge gas and the total pressure of the discharge gas composition.

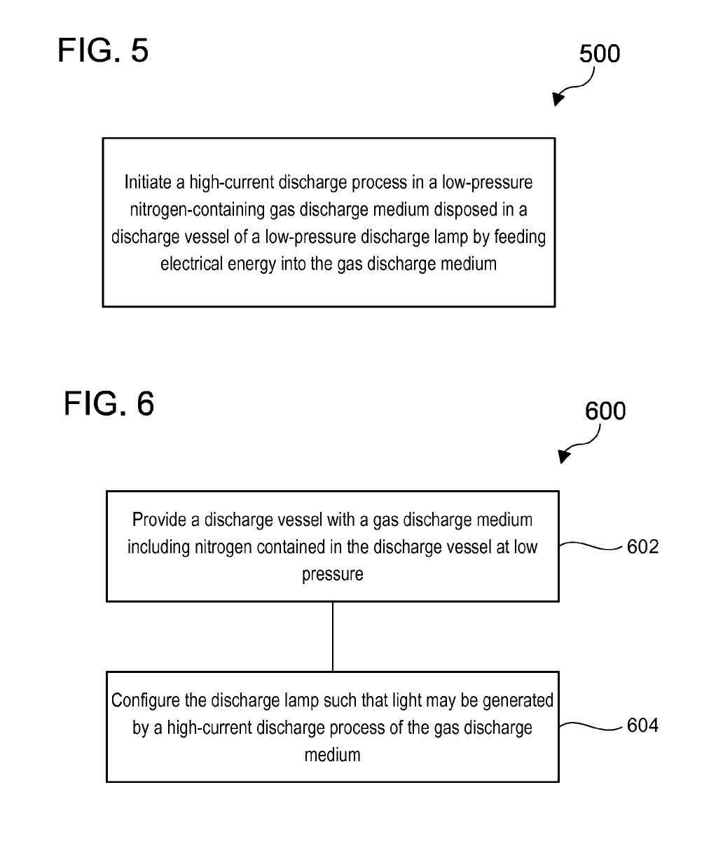

FIG. 5 shows a method 500 of generating light in accordance with an embodiment of the invention. The method 500 includes initiating a high-current discharge process in a low-pressure nitrogen-containing gas discharge medium disposed in a discharge vessel of a low-pressure discharge lamp by feeding electrical energy into the gas discharge medium. In accordance with an embodiment, a nitrogen arc discharge process may be initiated in a low-pressure nitrogen-containing gas discharge medium disposed between first and second electrodes of a low-pressure discharge lamp by feeding electrical energy into the gas discharge medium using the first and second electrodes. In accordance with an embodiment, an oxide electrode may be used for at least one of the first and second electrodes of the low-pressure discharge lamp. In accordance with another embodiment, the high-current discharge process may be initiated by inductively coupling the electrical energy into the gas discharge medium. In accordance with an embodiment, a phosphor may be used to at least partially convert ultraviolet radiation generated in the nitrogen discharge process into visible light radiation. The phosphor may be configured in accordance with one of the embodiments described herein. The low-pressure gas discharge medium may have a pressure in accordance with one of the embodiments described herein. Furthermore, the low-pressure gas discharge medium may have a composition in accordance with one of the embodiments described herein.

FIG. 6 shows a method 600 of manufacturing a low-pressure discharge lamp in accordance with an embodiment of the invention. The method 600 includes providing a discharge vessel with a gas discharge medium including nitrogen contained in the discharge vessel at low pressure (cf. reference numeral 602), and configuring the discharge lamp such that light may be generated by a high-current discharge process of the gas discharge medium (cf. reference numeral 604). In accordance with an embodiment, first and second electrodes may be disposed at least in part in the discharge vessel. In accordance with an embodiment, at least one of the first and second electrodes may include an oxide material. In accordance with another embodiment, the discharge lamp may be configured as an inductively coupled lamp. The discharge vessel and/or the gas discharge medium and/or the electrodes may be configured in accordance with at least one of the embodiments described herein. In accordance with an embodiment, a phosphor may be provided in the discharge vessel, the phosphor being configured to convert ultraviolet radiation generated by the gas discharge medium in the high-current discharge process into visible radiation. The phosphor may be configured in accordance with at least one of the embodiments described herein.

In the following, certain features and effects of exemplary embodiments of the invention are described.

In accordance with some embodiments of the invention, light may be generated by a plasma discharge (in other words, a high-current discharge) in a nitrogen/noble gas mixture (in other words, a gas mixture including nitrogen and a noble gas, e.g. argon in accordance with an embodiment) at low pressure, for example at a pressure of less than 150 torr (200 mbar) in accordance with an embodiment, e.g. in a range from approximately 0.1 torr to approximately 40 torr in accordance with an embodiment, e.g. approximately 1 torr in accordance with an embodiment.

In accordance with some embodiments, gas discharge lamps are provided that use a low-pressure nitrogen high-current discharge process to generate visible light.

In the context of this application, the term “high-current discharge” may be understood to refer to gas discharges having a discharge current with a high current magnitude, for example a current magnitude that is higher than a current magnitude in a glow-discharge. In accordance with some embodiments, a high-current discharge may include gas discharges having a discharge current with a magnitude in the range from approximately 100 mA to approximately 2 A.

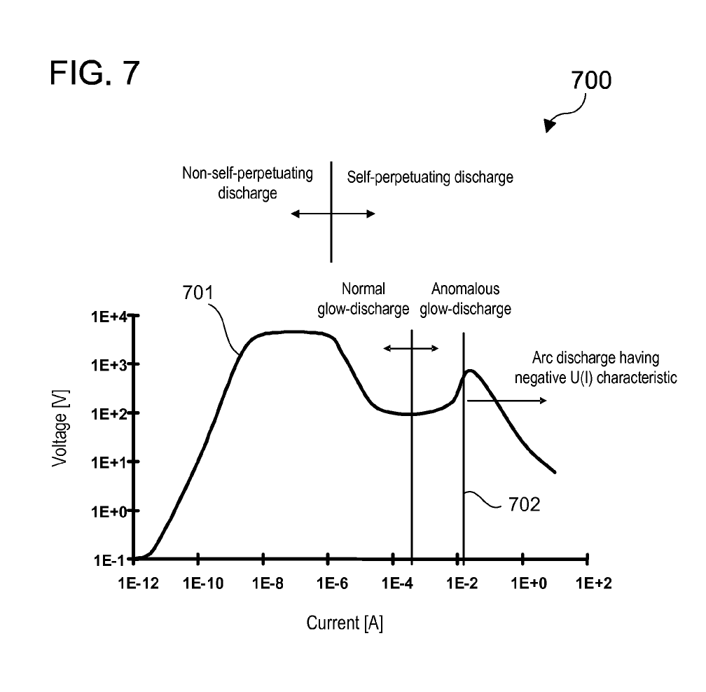

FIG. 7 shows a U(I) diagram 700 that illustrates schematically a characteristic U(I) curve 701 of a gas discharge and different discharge regimes in an exemplary gas discharge. In the diagram 700, the high-current discharge regime corresponds to the region that is right of the line 702.

Gas discharge lamps in accordance with some embodiments may include electrodes for coupling electrical energy into the gas discharge medium. In this case, the high-current discharge process may be an arc discharge process, wherein the term “arc discharge” may be understood to refer to a high-current discharge, wherein clearly an electric arc is generated in the gas discharge medium between the electrodes. An arc discharge usually requires a higher ignition voltage compared to the ignition voltage of a glow-discharge process in the gas discharge medium. In other words, the arc discharge process may be ignited by applying a high voltage to the electrodes, for example, a few hundred volts, e.g. more than 400 volts, although, as will be readily understood by a person skilled in the art, the precise value may depend from the composition of the gas discharge medium. After ignition of the arc discharge, a rapid voltage drop may be observed, for example, down to a value of a few tens of volts, e.g. to about 40 volts, and the voltage needed to maintain the arc discharge (also referred to as burning voltage) may thus be considerably lower compared to the case of the glow-discharge while at the same time the discharge current in the arc discharge may be higher than in the glow-discharge. Gas discharge lamps in accordance with some embodiments may be configured as inductively coupled lamps, wherein the electrical energy may be coupled inductively into the gas discharge medium.

In accordance with an embodiment, electrical energy that may be used to initiate (in other words, ignite) and/or carry out the discharge process may be introduced by oxide electrodes, such as those that are used in conventional fluorescent lamps.

In accordance with some embodiments, at least one of the electrodes may be configured as a filament, e.g. as a tungsten filament, that is coated with a mixture containing barium oxide and at least one of calcium oxide and strontium oxide, for example a mixture of barium oxide and calcium oxide in accordance with an embodiment, or a mixture of barium oxide and strontium oxide in accordance with another embodiment, or a mixture of barium oxide, calcium oxide and strontium oxide in accordance with still another embodiment. In accordance with another embodiment, the filament, e.g. the tungsten filament, may be coated only with barium oxide.

In accordance with some embodiments, the oxide coating may serve as an emitter material (that is, as a material that is capable of emitting electrons) and may serve to lower the electron work function of the electrode, and thus may lower the electrode temperature at which emission of electrons may be achieved. For example, in accordance with some embodiments the electron work function of tungsten, which is about 4.5 eV, may be lowered to a value of about 2 eV by coating a tungsten electrode with an oxide material containing barium oxide, although in accordance with other embodiments, other values of the electron work function may be achieved by using different suitable emitter materials.

In accordance with some embodiments, the discharge lamp may include an electrode heating for heating up at least one of the oxide electrodes (e.g. the tungsten filaments coated with barium oxide in accordance with an embodiment). For example, in accordance with an embodiment the electrode heating may be configured to preheat the electrodes before ignition of the nitrogen discharge in order to assist the ignition of the discharge.

In accordance with some embodiments, the oxide electrodes (e.g. the tungsten filaments coated with barium oxide in accordance with an embodiment) may be configured in such a manner that the respective discharge current in the discharge lamp may heat up the electrodes to a temperature that corresponds to a hot-to-cold resistance ratio (Rₕ/R_{c}) in the range between about 4 and 6. In other words, the electrodes may be configured such that for the ratio Rₕ/R_{c} between the electrical resistance R_{c} of the electrode at room temperature (in other words, in a “cold” state where no current flows through the electrode) and the electrical resistance Rₕ of the electrode at operating temperature (in other words, in a “hot” state where current flows through the electrode) it holds true that 4≦Rₕ/R_{c}≦6.

In accordance with some embodiments, the electrodes may be configured as filaments (e.g. tungsten filaments) and may be configured in accordance with one or more specifications described in the IEC 60081 and/or IEC 60901 standards, e.g. with respect to thermoelectric properties of the filament (e.g. ratio Rₕ/R_{c}). For example, in accordance with an embodiment the electrical resistance of the electrode filament may be adapted to the desired discharge current as described in the aforementioned standards.

In accordance with an embodiment, the discharge current may be in the range from approximately 100 mA to approximately 500 mA, for example in the range from approximately 250 mA to approximately 350 mA in accordance with an embodiment, e.g. approximately 300 mA in accordance with an embodiment.

In accordance with some embodiments, a power density with an order of magnitude of approximately 0.1 W/cm³ may be achieved, wherein the term “power density” may be understood to refer to the ratio of electrical power coupled into the lamp to discharge vessel volume.

In accordance with some embodiments, e.g. when argon is used as background gas, the emitted radiation may be distributed in a relatively uniform manner over spectral lines in the range from approximately 260 nm to approximately 2500 nm with a gap in the range from approximately 450 nm to approximately 550 nm. In accordance with some embodiments, this gap may be closed by an appropriate phosphor, wherein only relatively little conversion losses may occur. In accordance with other embodiments, further gas additions such as, for example, an addition of hydrogen or oxygen to the nitrogen/noble gas mixture, or variations of the background gas in the gas mixture may be applied to achieve, for example, a variation of the emission spectrum such that the use of a phosphor may be avoided.

In accordance with some embodiments, gas discharge lamps are provided, wherein mercury, which is used in conventional discharge lamps as light-generating element, is replaced by nitrogen. One advantage of using nitrogen in a discharge lamp is that the use of poisonous elements or elements that are harmful to the environment (such as mercury or metal halides) may be avoided. Another advantage of using nitrogen as light-generating element is that the obtainable luminous efficacy may be completely or almost completely independent from temperature. In other words, the strong temperature dependence seen in conventional Hg based discharge lamps may be avoided. Another advantage of using nitrogen is that oxide electrodes, such as those used in conventional fluorescent lamps, may be used to couple electrical energy into the discharge lamp. That is, in accordance with some embodiments, low-pressure mercury-free discharge lamps are provided, in which oxide electrodes may be used. This is generally not possible with other conventional mercury-free discharge lamps, which generally use halogen compounds (e.g. metal halides), since the oxide electrodes will be destroyed by the halogen compounds.

In accordance with some embodiments, the electrical energy that is used to carry out the discharge process may be coupled into the system by means of oxide electrodes. In other words, oxide electrodes such as those used in conventional fluorescent lamps may be used.

In accordance with some embodiments, gas discharge lamps are provided that use a nitrogen high-current discharge process (e.g. a nitrogen arc discharge process in accordance with some embodiments) and provide an intensive total radiation. In accordance with various embodiments, the discharge process burns in a stable and homogeneous manner.

Another advantage is that, in accordance with some embodiments, gas discharge lamps are provided that are easy to manufacture.

Discharge lamps in accordance with some embodiments may have a discharge vessel that is similar in shape and/or dimensions to discharge vessels of conventional fluorescent lamps, e.g. of conventional (straight) fluorescent tubes in accordance with an embodiment, or of compact fluorescent lamps in accordance with other embodiments.

For example, in accordance with some embodiments, the discharge vessel may have a straight tube geometry as used in conventional fluorescent lamps, having suitable geometric dimensions (e.g. with respect to the tube diameter and/or the tube length). In accordance with some embodiments, the geometric dimensions of the tube may be adapted to meet for example given technical and/or design specifications. In this context, it may be taken into account that the lamp efficacy generally increases with decreasing ratio between the discharge current and cross-sectional area of the tube. In accordance with an embodiment, the tube diameter may for example be chosen to be large enough such that a sufficiently high value of the discharge current and thus a sufficiently high wattage and light output may be achieved with the lamp. In addition, it may be taken into account that there is generally a small area in front of the electrodes of the lamp (also referred to as cathode area) where no light is produced. In accordance with an embodiment, the tube length may for example be chosen such that the fraction of this area (in other words, the ratio between the length of this area and the discharge length) is sufficiently small such that the efficacy of the lamp is sufficiently high. In addition, it may be taken into account that the lamp voltage generally increases with increasing length of the discharge. In accordance with an embodiment, the tube length (and thus the discharge length) may be chosen such that a lamp voltage of about 200 V to 250 V will not be exceeded such that a control gear (e.g. the electronic ballast) may be designed with reasonable effort.

In accordance with some embodiments, the discharge vessel may have a geometry including one or more bended tubes joined together, or a spiral geometry, as used in compact fluorescent lamps. An advantage of the compact fluorescent lamp geometry can be seen in that a light source may be provided that is more compact than a straight tube. A discharge vessel with a spiral geometry may for example allow for a long discharge length and small lamp dimensions.

In accordance with some embodiments, a nitrogen discharge process described herein may be used with an electrodeless inductively coupled lamp. In other words, in accordance with an embodiment, a discharge lamp may be provided that may be configured in accordance with one or more of the embodiments described herein (e.g. with respect to geometry of the lamp and/or electrical operating characteristics and/or composition of gas discharge medium, etc.) except that the electrical power used to operate the lamp is inductively coupled into the gas discharge medium. That is, instead of having electrodes disposed in the discharge vessel to ignite and maintain the discharge process in the gas discharge medium, in case of an electrodeless lamp, the energy used to ignite and maintain the discharge process may be provided by means of an alternating magnetic field, e.g. a high-frequency magnetic-field. In accordance with an embodiment, the magnetic field may have a frequency of several hundred kHz, e.g. about 250 kHz in accordance with one embodiment. In accordance with another embodiment, the magnetic field may have a frequency in the MHz range, although in accordance with other embodiments, the magnetic field may have other frequencies. In accordance with some embodiments, the magnetic field may be induced by an inductance that may be arranged near the discharge vessel, for example outside the discharge vessel, such that the induced magnetic field may at least partially penetrate the gas discharge medium contained in the discharge vessel. In accordance with an embodiment, the lamp may be operated in the high current region. For example, in accordance with an embodiment, the discharge current may be in the range from approximately 0.2 A to approximately 2 A. Thus, in accordance with an embodiment, an electrodeless nitrogen discharge lamp with inductive coupling may be provided that operates with significantly higher discharge current compared to conventional approaches.

A low-pressure discharge lamp in accordance with an embodiment includes a discharge vessel, a gas discharge medium including nitrogen contained in the discharge vessel at low pressure, and first and second oxide electrodes disposed at least in part in the discharge vessel, wherein the discharge lamp is configured such that light may be generated by a nitrogen arc discharge process between the first and second oxide electrodes. In accordance with an embodiment, the gas discharge medium further includes at least one of the following gases: argon, helium, neon, xenon, krypton. In accordance with another embodiment, the discharge lamp further includes a phosphor that is configured to convert ultraviolet radiation generated by the nitrogen arc discharge process into visible radiation. In accordance with another embodiment, the phosphor includes at least one of the following materials: BaMgAl₁₀O₁₇:Eu, (Ba₁₋ₓSrₓ)MgAl₁₀O₁₇:Eu,Mn, Sr₄Al₁₄O₂₅:Eu.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A low-pressure discharge lamp comprising:
a discharge vessel;
a gas discharge medium comprising nitrogen contained in the discharge vessel at low pressure;
wherein the discharge lamp is configured such that light may be generated by a high-current discharge process of the gas discharge medium.

2. The low-pressure discharge lamp as claimed in claim 1, further comprising:
a first electrode and a second electrode disposed at least in part in the discharge vessel;
wherein the high-current discharge process is an arc discharge process between the first and second electrodes.

3. The low-pressure discharge lamp as claimed in claim 2, wherein at least one of the first and second electrodes comprises an oxide material.

4. The discharge lamp as claimed in claim 3, wherein the oxide material comprises at least one of the following oxides: barium oxide, strontium oxide, calcium oxide.

5. The discharge lamp as claimed in claim 3, wherein the at least one electrode that comprises the oxide material further comprises tungsten material, wherein the tungsten material is covered by the oxide material.

6. The discharge lamp (150) as claimed in claim 1, wherein the discharge lamp is configured such that the high-current discharge process may be initiated by inductively coupling electrical energy into the gas discharge medium.

7. The discharge lamp as claimed in claim 1, wherein the gas discharge medium further comprises a noble gas.

8. The discharge lamp as claimed in claim 7, wherein the noble gas comprises at least one of the following gases: argon, helium, neon, krypton, xenon.

9. The discharge lamp as claimed in claim 1, wherein the pressure of the gas discharge medium is less than or equal to approximately 150 torr.

10. The discharge lamp as claimed in claim 9, wherein the pressure of the gas discharge medium is in the range from approximately 0.1 torr to approximately 40 torr.

11. The discharge lamp as claimed in one of claim 1, further comprising a phosphor disposed in the discharge vessel.

12. The discharge lamp as claimed in claim 11, wherein the phosphor is configured to at least partially absorb light energy in the ultraviolet wavelength range.

13. The discharge lamp as claimed in claim 12, wherein the phosphor is further configured to at least partially re-emit the absorbed light energy as visible light.

14. The discharge lamp as claimed in claim 13, wherein the phosphor is configured to absorb light energy in the wavelength range from approximately 260 nm to approximately 400 nm and re-emit the absorbed light energy as light having an emission maximum in the wavelength range from approximately 450 nm to approximately 550 nm.

15. The discharge lamp as claimed in one of claim 1, wherein the phosphor comprises at least one of the following materials:
BaMgAl₁₀O₁₇:Eu;
(Ba₁₋ₓSrₓ)MgAl₁₀O₁₇:Eu,Mn;
Sr₄Al₁₄O₂₅:Eu.

16. The discharge lamp as claimed in claim 1, wherein the gas discharge medium further comprises hydrogen.

17. A method of generating light, comprising:
initiating a high-current discharge process in a low-pressure nitrogen-containing gas discharge medium disposed in a discharge vessel of a low-pressure discharge lamp by feeding electrical energy into the gas discharge medium.

18. The method as claimed in claim 17, wherein the discharge lamp comprises first and second electrodes disposed at least in part in the discharge vessel, and wherein the high-current discharge process is an arc discharge process between the first and second electrodes that is initiated by feeding the electrical energy into the gas discharge medium using the first and second electrodes.

19. The method as claimed in claim 18, further comprising using an oxide electrode for at least one of the first and second electrodes of the discharge lamp.

20. The method as claimed in claim 17, wherein the high-current discharge process is initiated by inductively coupling the electrical energy into the gas discharge medium.

21. The method as claimed in claim 17, the gas discharge medium further comprising at least one of the following gases: argon, helium, neon, xenon, krypton.

22. The method as claimed in claim 17, further comprising using a phosphor to at least partially convert ultraviolet radiation generated in the high-current discharge process into visible light radiation.

23. The method as claimed in claim 22, further comprising using one of the following materials as the phosphor:
BaMgAl₁₀O₁₇:Eu;
(Ba₁₋ₓSrₓ)MgAl₁₀O₁₇:Eu,Mn;
Sr₄Al₁₄O₂₅:Eu.

24. The method as claimed in claim 17, further comprising the low-pressure gas discharge medium having a pressure of less than or equal to approximately 150 torr.

25. A method of manufacturing a low-pressure gas discharge lamp, comprising:
providing a discharge vessel with a gas discharge medium including nitrogen contained in the discharge vessel at low pressure;
configuring the discharge lamp such that light may be generated by a high-current discharge process of the gas discharge medium.
